(19) United States
(12) Patent Application Publication
(10) Pub. No.: US 2018/0105294 A1
(43) Pub. Date: Apr. 19, 2018

(54) METHODS AND SYSTEMS FOR PREFILLING SYRINGES

(71) Applicants: Bourjois Abboud, Houston, TX (US); Joel Henry, Manvel, TX (US); Bruce Schroeder, Manvel, TX (US)

(72) Inventors: Bourjois Abboud, Houston, TX (US); Joel Henry, Manvel, TX (US); Bruce Schroeder, Manvel, TX (US)

(21) Appl. No.: 15/292,500

(22) Filed: Oct. 13, 2016

(51) Int. Cl. B65B 3/00; A61J 1/16; A61J 1/20; A61J 1/18; A61J 1/14; B65B 3/12; B65B 7/28; B65B 43/50; G03B 15/14; G01F 23/02; G01N 21/90

(52) U.S. Cl. CPC B65B 3/003; A61J 1/16; A61J 1/20; A61J 1/18; A61J 1/1418; B65B 3/12; A61J 2205/50; B65B 43/50; B65B 7/2835; G03B 15/14; G01F 23/02; G01N 21/90; B65B 7/2807

(57) ABSTRACT

A system for filling syringes that includes a syringe filling machine. The syringe filling machine includes a syringe feeder, a syringe loader coupled with the syringe feeder, a starwheel, one or more inspection stations provided around the starwheel, a syringe filling station adjacent the starwheel, a cap feeder, a cap loader in communication with the cap feeder and adjacent the starwheel, and an ejection station adjacent the starwheel. The syringe loader is operable to receive one or more syringes and to feed the one or more syringes into the starwheel. The starwheel is operable to move the one or more syringes between the one or more inspection stations, the syringe filling station, and the cap loader.

### BACKGROUND

The use of prefilled syringes by medical professionals and patients is becoming more common due to a number of benefits that can be realized by large scale filling operations. Some benefits of using prefilled syringes may include reduced overfill of the syringes, enhanced differentiation between different syringes, improved efficiency when filling syringes, increased patient compliance, ease of use for healthcare professionals and patients, and reduced risk of dosage error and/or contamination. However, while there are a number of benefits that can be realized through the use of prefilled syringes, a significant amount of time and money is required to ensure that during pre-filling, certain aspects of the filling process comply with a litany of health and safety standards. Thus, the preparation for and process of pre-filling syringes can be onerous. The applicable health and safety standards may include the requirement that all syringe filling take place in a sterile environment, all components of the pre-filling system are continually subjected to one or more anti-contamination procedures, all unused syringes and caps be discarded after use, and/or that any operators be subjected to certain decontamination procedures.

As the above mentioned safety standards can be expensive and time consuming, currently, automated syringe systems are limited to large-scale processes that output a large amount of prefilled syringes. Such large-scale processes typically require a lengthy start up time and are limited to filling a single type (e.g. size, material, etc.) of syringe due to the inability to interchange parts easily within the system. The use of large-scale processes also regularly results in a large number of discarded or unusable prefilled syringes and can be limited to filling syringes with a single compound. While large-scale syringe filling processes may be beneficial under certain circumstances, for instance when large quantities of a specific compound in prefilled syringes are necessary, these large-scale processes are not useful for those who require smaller amounts of prefilled syringes. Moreover, large-scale processes typically involve integrated parts of a machine that are not easily interchangeable. Still further, large-scale processes are not conducive to allowing different compounds to be filled within the syringes.

It would therefore be desirable to develop systems and methods for pre-filling syringes that solves one or more of the abovementioned problems associated with large-scale syringe filling processes.

### SUMMARY OF THE INVENTION

In one aspect of the disclosure, a system for filling syringes includes a syringe filling machine. The syringe filling machine includes a syringe feeder, a syringe loader coupled with the syringe feeder, a starwheel, one or more inspection stations provided around the starwheel, a syringe filling station adjacent the starwheel, a cap feeder, a cap loader in communication with the cap feeder and adjacent the starwheel, and an ejection station adjacent the starwheel. The syringe loader is operable to receive one or more syringes and feed the one or more syringes into the starwheel, and the starwheel is operable to move the one or more syringes between the one or more inspection stations, the syringe filling station, and the cap loader.

In another aspect of the disclosure, a system for filling syringes includes a syringe filling machine that includes a syringe feeder having a vibratory track, a syringe loader coupled with the syringe feeder, a starwheel rotatable about a central axis, one or more inspection stations provided adjacent the starwheel, a syringe filling station adjacent the starwheel, a cap feeder operable to align one or more caps in a capping orientation, and a cap loader in communication with the cap feeder. The starwheel is operable to move the one or more syringes between the one or more inspection stations, the syringe filling station, and the cap loader.

In yet another aspect of the disclosure, a method of filling syringes comprise the steps of inputting one or more variables via a user interface, loading one or more syringes into a syringe loader, loading the one or more syringes into a starwheel, biasing the one or more syringes, via the starwheel, to the following stations: a first inspection station, a filling station, a second inspection station, and a cap loader. The method further includes the steps of providing one or more caps to a cap feeder, biasing the one or more caps to the cap loader, and securing one of the one or more syringes with one of the one or more caps within the cap loader.

### DESCRIPTION OF THE DRAWINGS

FIG. 1 is a front elevational view of a generic syringe in an unfilled position that may be used with any of the systems described herein;

FIG. 2 is a front elevational view of the syringe of FIG. 1 in a filled state;

FIG. 3 is a schematic top view of a syringe filling system as disclosed herein;

FIG. 4 is a partial perspective view of the syringe filling system of FIG. 3;

FIG. 5 is a perspective view of some components of the syringe filling system of FIG. 1 including a control box;

FIG. 6 is a partial perspective view of a syringe feeder of the system of FIG. 3;

FIG. 7 is another perspective view of the syringe feeder of the syringe filling system of FIG. 3;

FIG. 8 is a perspective view of a syringe loader of the syringe filling system of FIG. 3 in a pre-loading configuration;

FIG. 9 is side a perspective view of the syringe loader of FIG. 8 in a loading configuration;

FIG. 10 is top perspective view of the syringe loader of FIG. 8 in the loading configuration;

FIG. 11 is a perspective view of a starwheel of the syringe filling system of FIG. 3 adjacent a first inspection station;

FIG. 12 is a perspective view of a gradation detection sensor of the syringe filling system of FIG. 3;

FIG. 13 is a perspective view of a filling station for filling syringes of the syringe filling system of FIG. 3;

FIG. 14 is a perspective view of the filling station of FIG. 13 in a pre-filling state;

FIG. 15 is a perspective view of the filling station of FIG. 13 prior to filling;

FIG. 16 is a perspective view of the filling station of FIG. 13 during filling of the syringe;

FIG. 17 is a perspective view of the filling station of FIG. 13 in a post-filling state;

FIG. 18 is a perspective view of a hopper of a cap feeder of the syringe filling system of FIG. 3;

FIG. 19 is a perspective view of a bowl of the cap feeder of FIG. 20;

FIG. 20 is a perspective view of portions of a cap loader;

FIG. 21 is another perspective view of portions of the cap loader of FIG. 20;

FIG. 22 is a further perspective view of portions of the cap loader of FIG. 20;

FIG. 23 is a perspective view of the cap loader of FIG. 20 in a pre-capping state;

FIG. 24 is a perspective view of the cap loader of FIG. 20 in a capping state;

FIG. 25 is a perspective view of an ejection station of the syringe filling system of FIG. 3; and

FIG. 26 is a flow chart illustrating a method of operating the syringe filling system as described herein.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

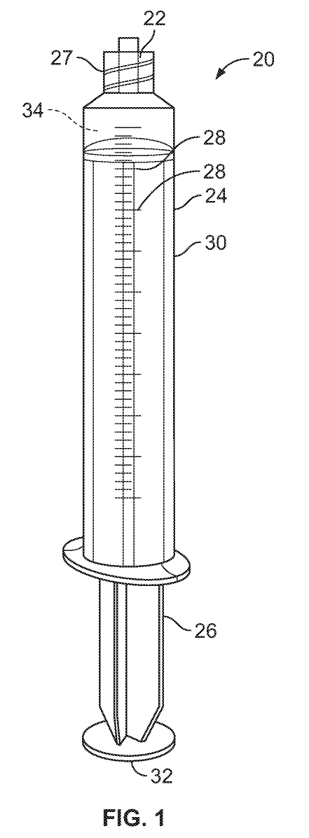

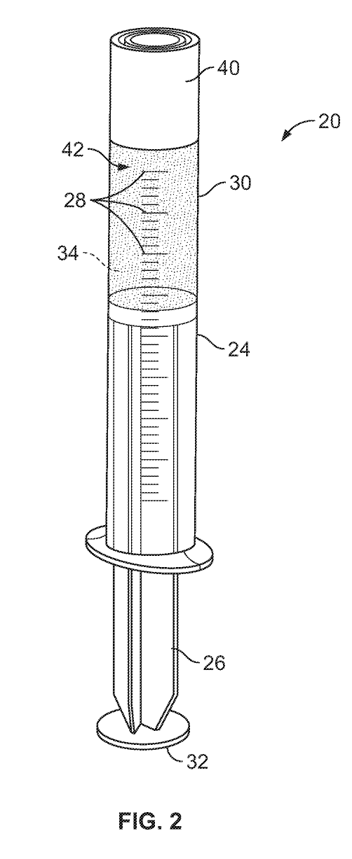

Before the systems and methods are described in detail, some general components that may be used within the system will be described. More specifically and referring to FIG. 1, a syringe 20 is shown in a pre-fill state having a nozzle 22 at an upper end, a substantially cylindrical barrel 24, and a plunger 26. The nozzle 22 includes a circular opening to allow for a composition to be inserted into and/or ejected therefrom. The nozzle 22 may further include one or more threads 27 circumscribing an exterior surface thereof that are designed to releasably receive a cap 40 (see FIG. 2) that retains the composition within the syringe 20. The syringe 20 may further include an attachment mechanism designed to receive a needle (not shown) or other injection implement.

A plurality of gradation markings 28 are provided along an exterior surface 30 of the barrel 24. The gradation markings 28 may be provided in any increments along the longitudinal axis of the barrel 24 and are used by the system 100 to determine if the syringe 20 has been properly filled. The syringe 20 also includes the plunger 26, which has a thumb rest 32, and is shown seated within the barrel 24 in FIG. 1. Retraction of the plunger 26 from the position shown in FIG. 1 draws air through the nozzle 22 into a chamber 34 within the barrel 24. It should be noted that the gradation markings 28 that are provided along typical syringes are not always consistent or exact, which is taken into account by the system 100 in some embodiments as disclosed herein.

Referring now to FIG. 2, the cap 40 is shown attached to the syringe 20 and is depicted in a filled and capped state. The cap 40 is cylindrical and may include corresponding threads (not shown) on an interior surface that are designed to interact with the threads 27 of the nozzle 22. In some embodiments, the cap 40 may be secured to the syringe 20 using other methods including press-fit, interference fit, and the like. The syringe 20 is also shown having a compound 42 disposed within its chamber 34. As will be described in greater detail hereinafter below, the purpose of this disclosure is to describe a system that automatically fills the syringe 20 or one or more syringes 20 with the compound 42, which may be any formulated compound, wherein the formulated compound may include a compound that is dissolved or added as a suspension in a liquid water based carrier. The systems and methods described herein preferably can complete this sequence repeatedly and in rapid succession.

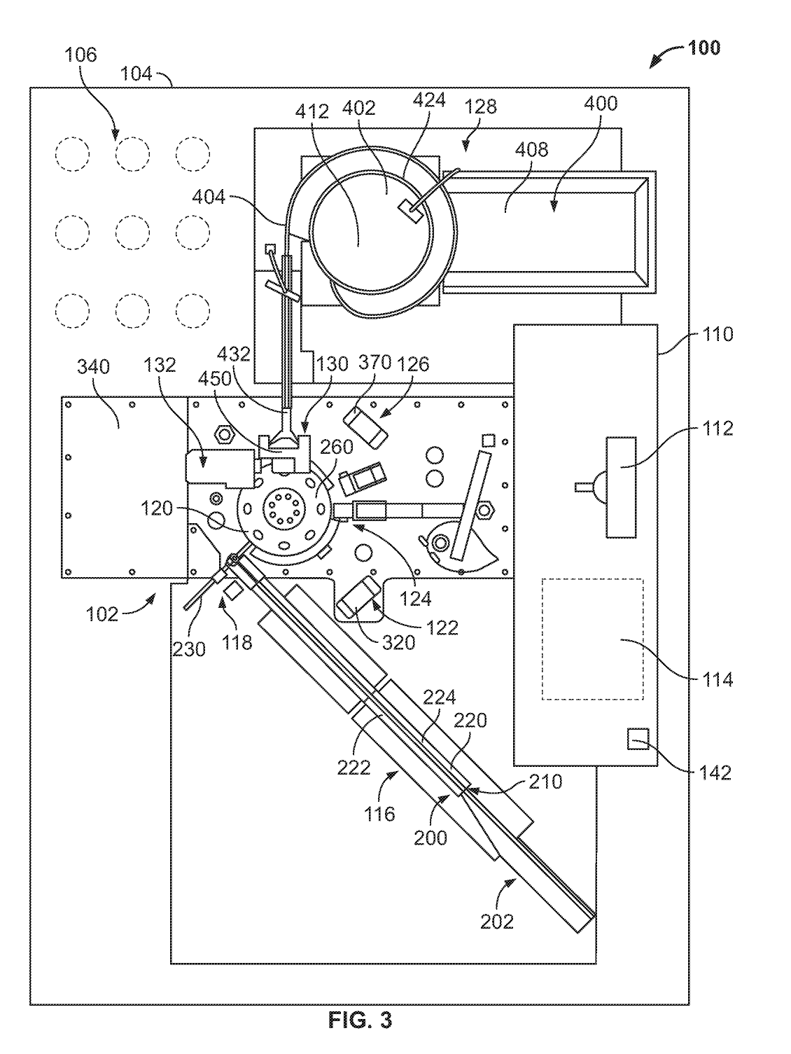

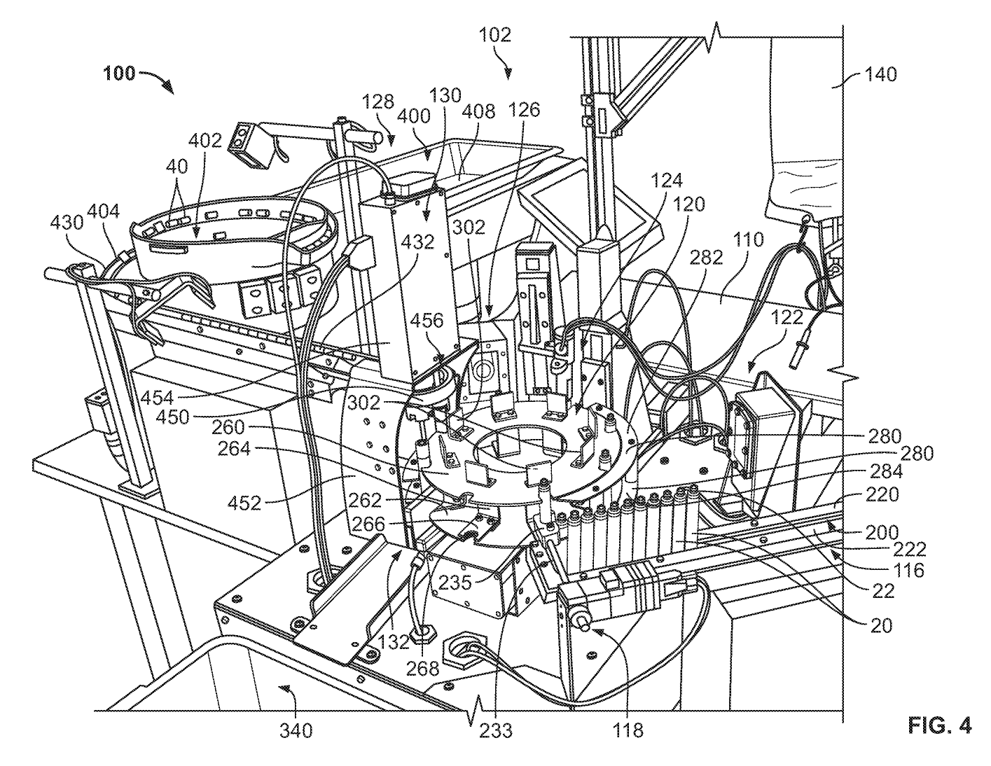

Referring now to FIGS. 3 and 4, a syringe filling system 100 is illustrated that is designed to load, inspect, and cap the syringes 20 as described above to a specified level or volume. The system 100 includes an automated syringe filling machine 102 as well as other components. The system 100 is generally automatic and allows syringes to be filled to a specified level by identifying and filling according to the gradation markings 28 located along the exterior surface 30 of the syringe 20 rather than using an absolute volume of the syringe 20 for filling, as will be described in greater detail hereinafter below. However, in some forms, the system 100 allows for automatic filling based on a predetermined volume.

The system 100 includes a number of components, including the syringe filling machine 102, a cleanroom 104, and a vacuum system 106. The syringe filling machine 102 includes a workstation 110, a control panel 112, a control box 114, a syringe feeder 116, a syringe loader 118, a starwheel 120, a first inspection station 122, a filling station 124, a second inspection station 126, a cap feeder 128, a cap loader 130, and an ejection station 132. Each of the aforementioned components may be included within the system 100, or one or more components may be excluded from, or modified within, the system 100. In some embodiments, a single operator uses the control panel 112 located on the workstation 110 to input requirements for pre-filling a plurality of the syringes 20. The control box 114 receives the inputs, and outputs commands to one or more of the above listed components. In one embodiment, a medicine bag 140 (see FIG. 4) is hung adjacent the system 100 and includes the formulated compound to be dispensed into the syringes 20. During operation of the system 100, the medicine bag 140 is held above the filling station 124, so that head pressure is created and the formulated compound flows, due to gravity, toward the filling station 124. In lieu of a medicine bag 140, the formulated compound may be retained or otherwise in communication with the system 100 in other ways known in the art.

The cleanroom 104 and the vacuum system 106 are shown schematically in FIG. 3. The cleanroom 104 may be a modular cleanroom system that is a free standing structure that at least partially or fully surrounds and retains the syringe filling system 100. In some embodiments, the cleanroom 104 includes a plurality of fans. In some embodiments, the cleanroom 104 includes at least four, at least six, at least eight, or at least ten HEPA fan filter units (FFUs) that provide direct and continuous flow of particle free air through the enclosure. In addition to the continuous flow of air, the cleanroom provides light, which is useful for operation of the syringe filling system 100 and its various components. In some embodiments, the cleanroom 104 remains powered on during non-use of the system 100 to reduce the possibility of contamination to any of the components housed therein. The vacuum system 106 may comprise an oil free vacuum system that continuously pulls air from system actuators disposed within the cleanroom 104. The system actuators generally comprise any components of the system 100 that translate with respect to other components of the system 100. As the system actuators move, small particulate matter may be created and dispersed into the surrounding atmosphere as a result of the interaction of the moving parts that comprise the system actuators. The vacuum system 106 ensures that any released particulate matter does not contaminate the syringes 20 or the caps 40 and is expelled from the system 100 at a location spaced away from the pharmaceutical products that are used in the system 100. The vacuum system 106 is turned on by activating a switch 142 located along the workstation 110 or at some other location.

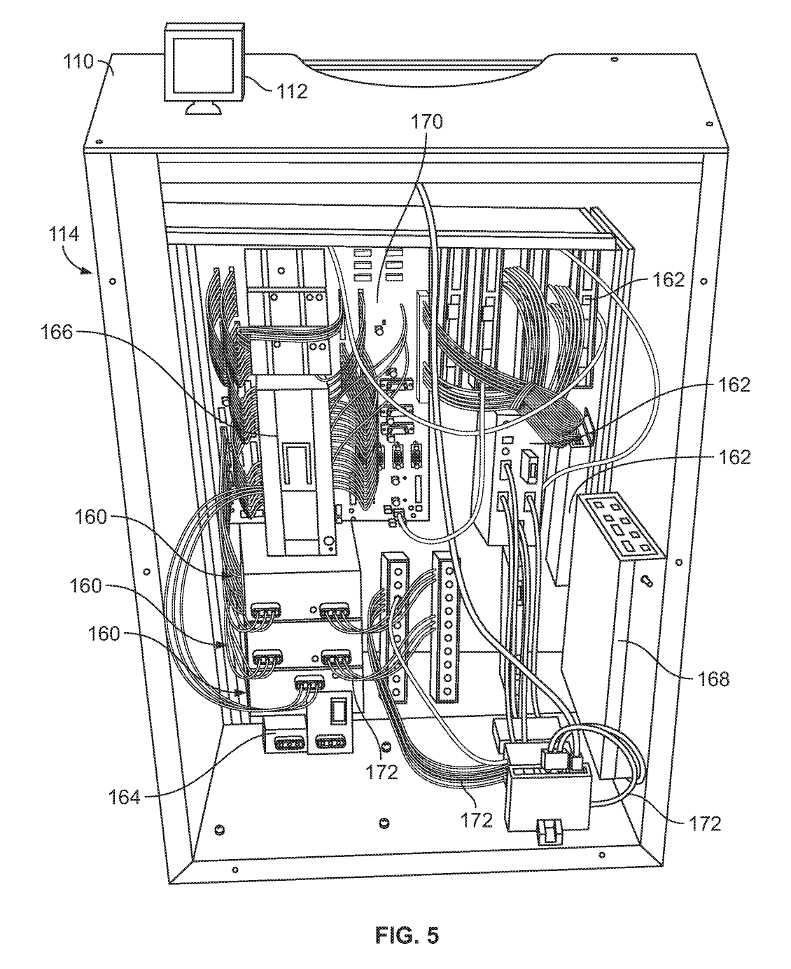

Now referring to FIG. 5, a portion of the workstation 110, the control panel 112, and the control box 114 are shown, with the front cover removed for clarity. The workstation 110 is where the operator spends a majority of her time during use of the system 100. One or more of the following operations can be completed at this station by the operator: prepare the medicine bags 140, install one or more filling connection lines, store boxes of syringes and/or caps, load syringes and/or caps, monitor system activity, and/or interface with the control panel 112. In some embodiments, the control panel 112 is a touch screen panel that is used to control the machine 102. The control panel 112 may be used to enter batch information and/or to start and stop the machine 102. The control panel 112 can also be used to control the cleanroom 104 and/or the vacuum system 106. The control panel 112 may be configured to alert the operator of any issues and/or warnings and is used to clear and recover from errors. The control panel 112 may include any type of interface that provides feedback to the operator, and may include one or more buttons, dials, switches, or other operational components that allow for the manipulation of any of the settings discussed hereinafter below. The control panel 112 may comprise a graphical user interface, or some other interface.

Still referring to FIG. 5, the control box 114 is shown. The control box 114 is designed to enclose many of the electronics of the system 100. In some embodiments, the control box 114 includes one or more of alternative power supplies 160, one or more controllers 162, a universal power supply 164, a programmable logic controller (PLC) 166, a computer 168, and a main printed circuit board (PCB) 170. The control box 114 may be located along any portion of the system 100, such that cords 172 that extend therefrom do not interact with the moving parts of the machine 102. In some instances, when the system 100 experiences a loss of power, the universal power supply 164 may allow the system 100 to fill and cap the syringes 20 that have already been loaded into the starwheel 120.

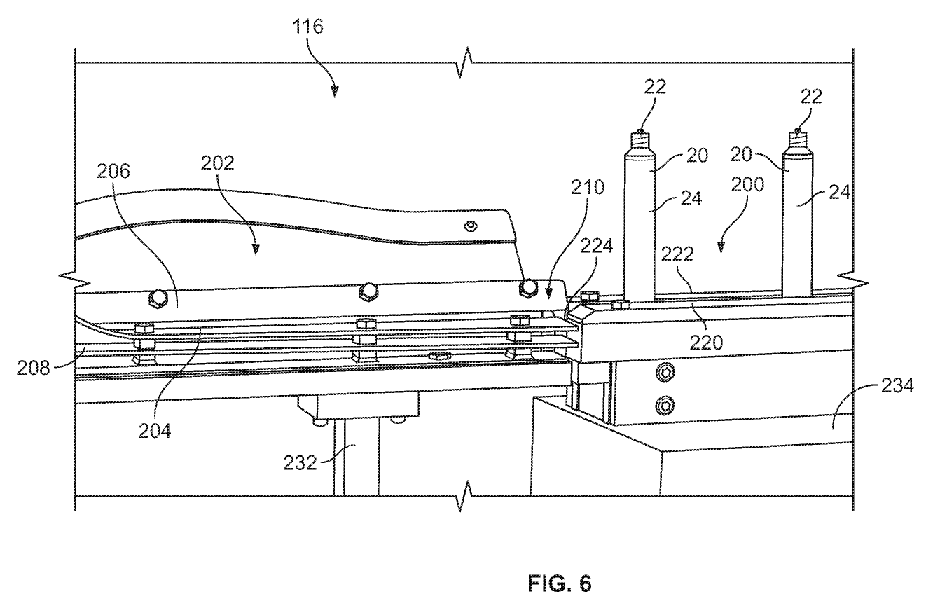

Referring now to FIG. 6, the syringe feeder 116 is shown in greater detail. In some embodiments, the syringe feeder 116 comprises a track 200 that is used to organize the syringes 20 for use in the system 100. The track 200 may be a vibratory track that biases the one or more syringes 20 therealong through the use of vibrations. The syringe feeder 116 also includes a loading dock 202, which is in communication with the track 200. The loading dock 202 includes a first flange 204, a second flange 206, and a slide 208. The slide 208 communicates with the thumb rest 32 of the plunger 26 of the syringe 20 while the first and second flanges 204, 206 hold the plunger 26 in place when it is biased along the slide 208 by the operator. An exit portion 210 of the loading dock 202 is in communication with the track 200, which allows the syringe 20 to enter the track 200.

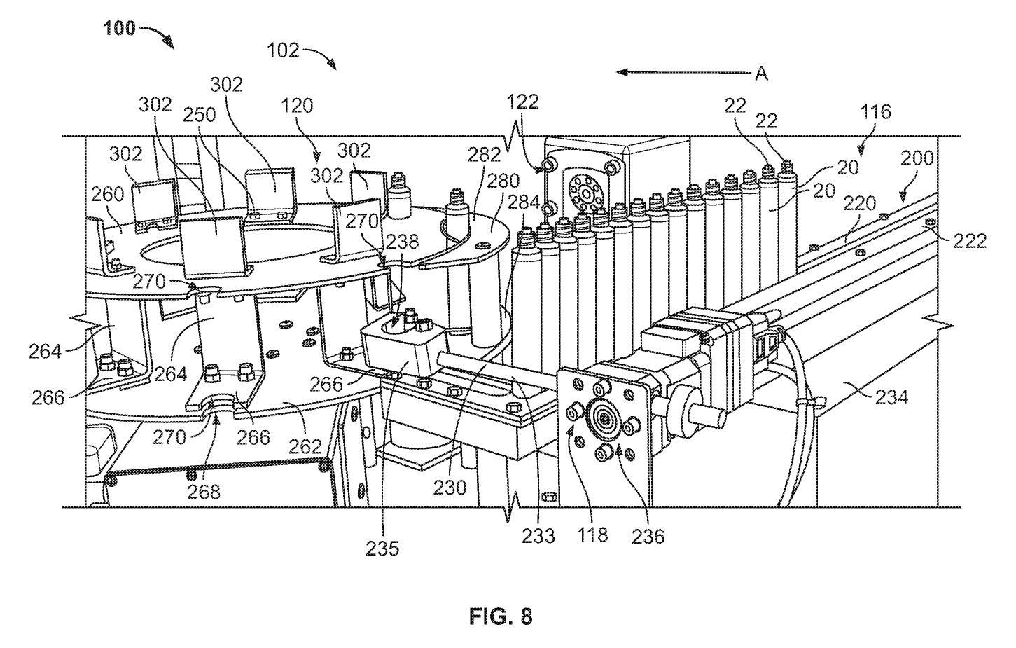

The track 200 includes a first rail 220, a second rail 222, and a vibrating rail 224, which are generally positioned similarly in alignment with the first flange 204, the second flange 206, and the slide 208, respectively. The vibrating rail 224 communicates with the thumb rest 32 of the plunger 26, while the first and second rails 220, 222 hold the syringe 20 in a vertical position as it is biased along the track 200 by vibrations induced via the vibrating rail 224. The one or more syringes 20 are biased along the vibratory track 200 until being queued adjacent a syringe actuator 230 (see FIG. 8), as discussed below. The loading dock 202 and the track 200 are shown supported by a stand 232 and a table 234, respectively, but any kind of supporting feature can be used to hold the loading dock 202 and the track 200 in place. In some embodiments, the loading dock 202 may be excluded. In some embodiments, the vibratory track 200 is a device that is used to feed individual component parts for an assembly oriented in a particular direction. Vibratory feeders or tracks generally rely on the mechanical behavior of a part, such that when gently shaken down a track that is shaped to fit the part, the parts will gradually be shaken so that they are all aligned and are lead to a destination point.

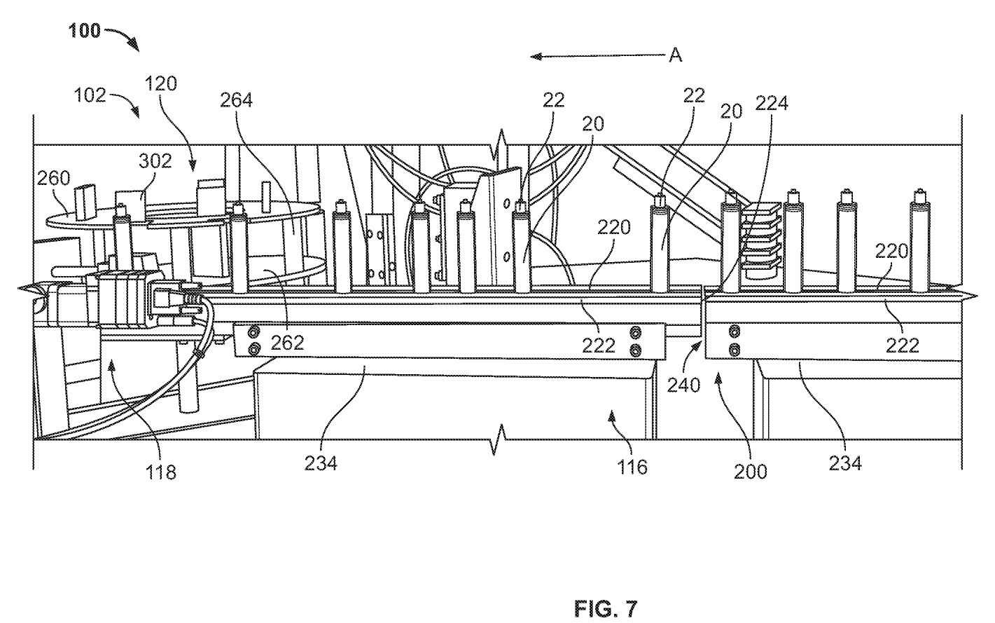

Referring now to FIGS. 7 and 8, the track 200 and the syringe loader 118 are shown in greater detail. Referring to FIG. 7, an intersection 240 between different portions of the track 200 is shown. As illustrated in the FIGS., the track 200 may include two or more separated portions. In some embodiments, the track 200 includes one portion. The intersection 240 may include a gap, or may not include a gap. The track 200 is shown with a plurality of the syringes 20 thereon, which travel in the direction depicted by an arrow A when the system 100 is in an operable configuration. The syringes 20 are generally biased along the track 200 in the direction of the arrow A until reaching the syringe loader 118. The syringe loader 118 includes the syringe actuator 230 (see FIG. 8), which may be configured to interact with and/or grasp the syringes 20, one at a time, from the syringe feeder 116 and insert the syringes 20 into the starwheel 120 at the beginning of each cycle. The syringe actuator 230 is one of the aforementioned system actuators.

Referring now to FIG. 8, the syringe actuator 230 includes an arm 233 and a claw 235, the arm 233 being in translatable communication with an arm motor 236. The arm 233 is generally cylindrical and elongated, while the claw 235 may be formed from a generally rectangular block having a cutout 238, which may be a circular, semi-circular, or half-racetrack shaped cutout, formed along a side thereof. The cutout 238 may be shaped and sized to correspond to the shape and/or size of the syringes 20 being contemplated for use within the system 100. The syringe actuator 230 may include other components not specifically discussed herein.

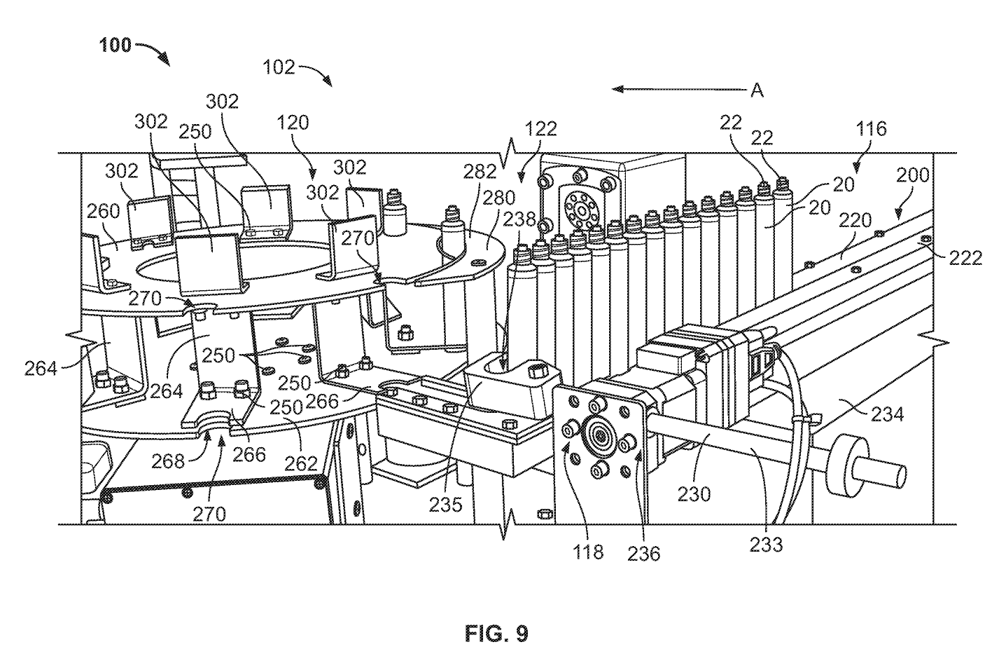

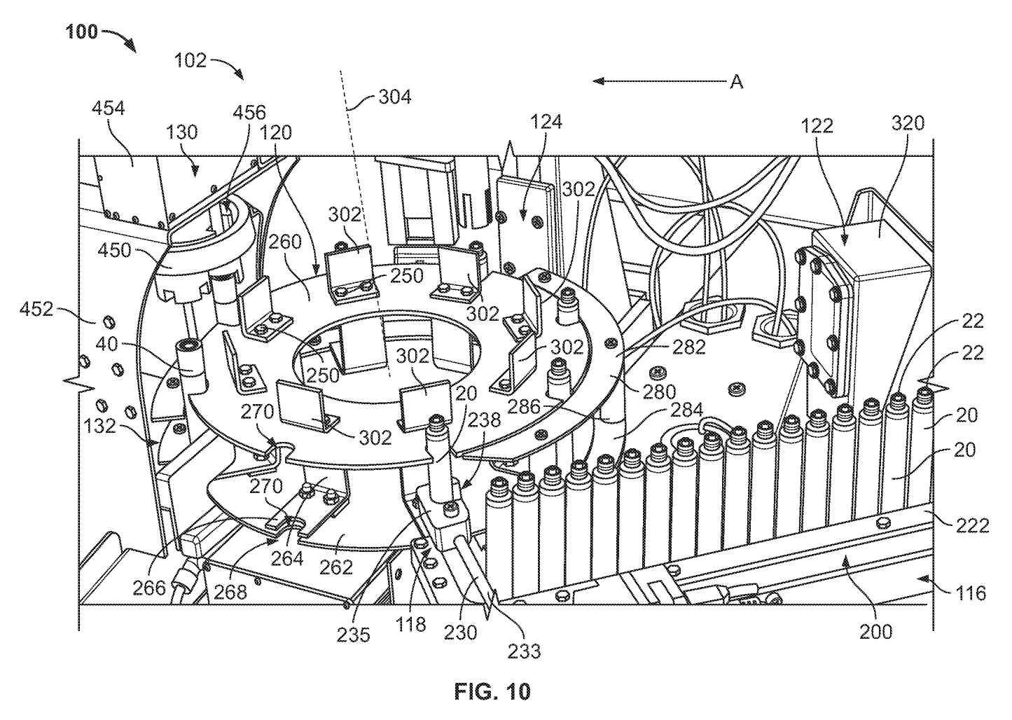

Referring to FIGS. 8 and 9, the arm 233 is configured to retract in a way that aligns the claw 235 with a first queued syringe 20. The arm 233 is shown in an unretracted state in FIG. 8 and is shown in a retracted state in FIG. 9. Once the arm 233 is retracted and aligned with the first queued syringe 20, the cutout 238 receives the first queued syringe 20, and, after the syringe 20 is securely within the cutout 238, the arm 233 biases the syringe 20 forward, into the starwheel 120, as shown in FIG. 10. The arm motor 236 is in electrical communication with one or more components disposed within the control box 114 via one or more of the cords 172, or via a wireless connection. In some embodiments, the control system 100 has built in error detection and recovery to automatically handle jammed syringes in the syringe loader 118 and can provide instructions to the syringe loader 118 to retry the cycle if necessary. Any of the components described herein may connected or coupled to another component via securement mechanisms 250, as described in greater detail hereinafter below and depicted throughout the figures.

The starwheel 120 is shown more clearly in FIG. 10 and is designed to contain and move the syringes 20 between each of the stations surrounding the starwheel 120. In some instances, the starwheel 120 is removable, thus, it is not permanently affixed to any component of the machine 102. The starwheel 120 is generally circular, and includes an upper disc 260 and a lower disc 262. The upper disc 260 and lower disc 262 are statically connected with one or more legs 264 via one or more of the securement mechanisms 250 which may include rivets, screws, bolts, or any other fastener known to those of ordinary skill in the art. In some forms, the one or more legs 264 include a foot 266 having a foot cutout 268 at a distal end thereof, which is formed to receive the one or more syringes 20 during the filling process. Each of the foot cutouts 268 may be generally semi-circular or semi-racetracked in shape to receive the one or more syringes 20 during the filling process. As illustrated in FIG. 10, the upper disc 260 and the lower disc 262 have a plurality of disc cutouts 270 located along the exterior sides thereof. In some forms, the disc cutouts 270 are the same shape as the one or more foot cutouts 268. In some forms, the disc cutouts 270 and the foot cutouts 268 have different shapes. The disc cutouts 270 may be formed to snugly receive the one or more syringes 20, however, the disc cutouts 270 may be larger depending on the desired configuration or operation of the starwheel 120.

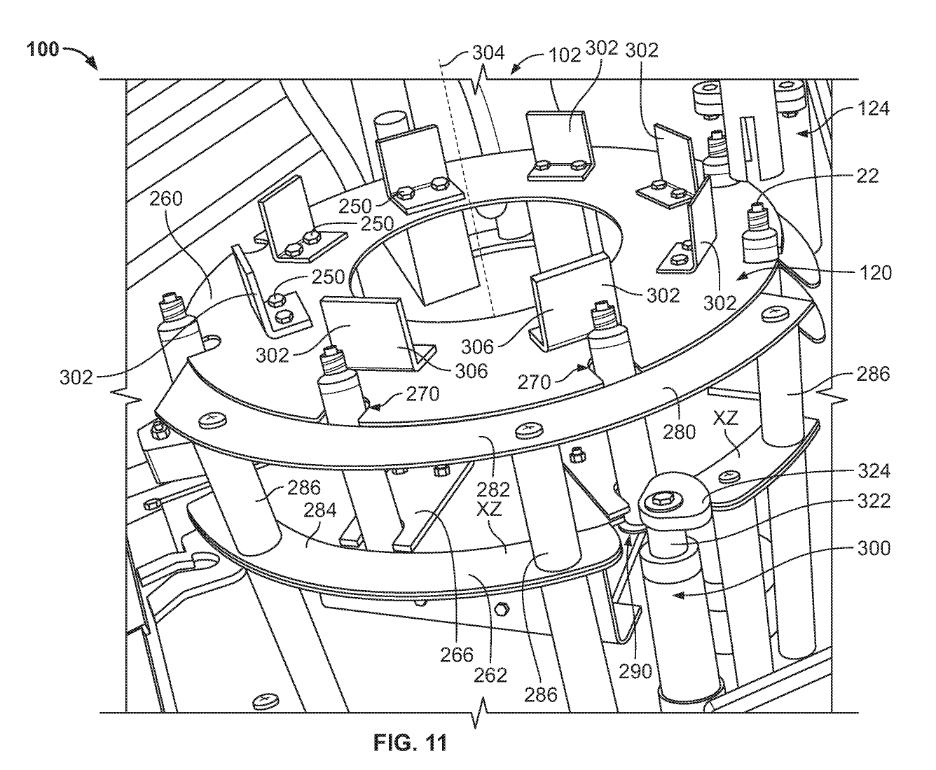

Referring to FIGS. 10 and 11, the disc cutouts 270 of the starwheel 120 are depicted as offset about every 45 degrees. In such an embodiment, eight legs 264 are included, being secured between the upper disc 260 and the lower disc 262 with one or more of the securement mechanisms 250, and being aligned with the disc cutouts 270. Referring specifically to FIG. 11, surrounding the starwheel 120 at one or more locations therearound are one or more support rails 280 that ensure the syringes 20 remain in place within the cutouts 268, 270 during the filling process. An upper support rail 282 and a lower support rail 284 are included between the syringe loader 118 and the filling station 124 to ensure that the syringes remain in place before inspection and filling. The upper support rail 282 and the lower support rail 284 are connected with one or more connection members 286, which may be elongate cylindrical members that are attached to the rails 282, 284 with one of the aforementioned securement mechanisms 250, or some other securement mechanism. The rails 282, 284 may be spaced apart from the discs 260, 262 by a space of between about 2 mm and about 6 mm, or between about 3 mm and about 5 mm, or about 4 mm. One or both of the rails 282, 284 may have a gap 290 (see FIG. 11) to provide space for an adjustment mechanism 300, as will be discussed in greater detail below. The rails 282, 284 may be biased toward the starwheel 120 with a spring, or a spring-like mechanism, such that the rails 282, 284 are moveable away from the starwheel 120, but are generally biased to be close to the starwheel 120.

Referring to FIG. 11, one or more back plates 302 may be included along and protrude upwardly from the upper disc 260, and may be located between the one or more cutouts 268, 270 and a central axis 304 of the starwheel 120. The one or more back plates 302 may be secured to the upper disc 260 with any one of the aforementioned securement mechanisms 250. The one or more back plates 302 includes a planar surface 306 that provides a visible contrast against which one or more sensors or cameras can detect the gradation markings 28 on the syringe 20 during the inspection aspects of the filling process. To that end, the back plates 302 are positioned adjacent (and behind) the syringe 20 with respect to the angle the camera or sensor is measuring. For example, when one of the syringes 20 is being visually inspected by one or more sensors, as discussed in greater detail below, the surface 306 provides a background so that accurate and consistent sensing can take place. The surface 306 may comprise any number of colors and/or finishes that better allow the sensing devices discussed below to sense characteristics of the syringes. In one specific embodiment, the back plates 302 may be provided with a non-glossy finish. In other embodiments, the back plates 302 may be provided with a matte white finish, or another color that contrasts with the black coloration of the gradation markings 28.

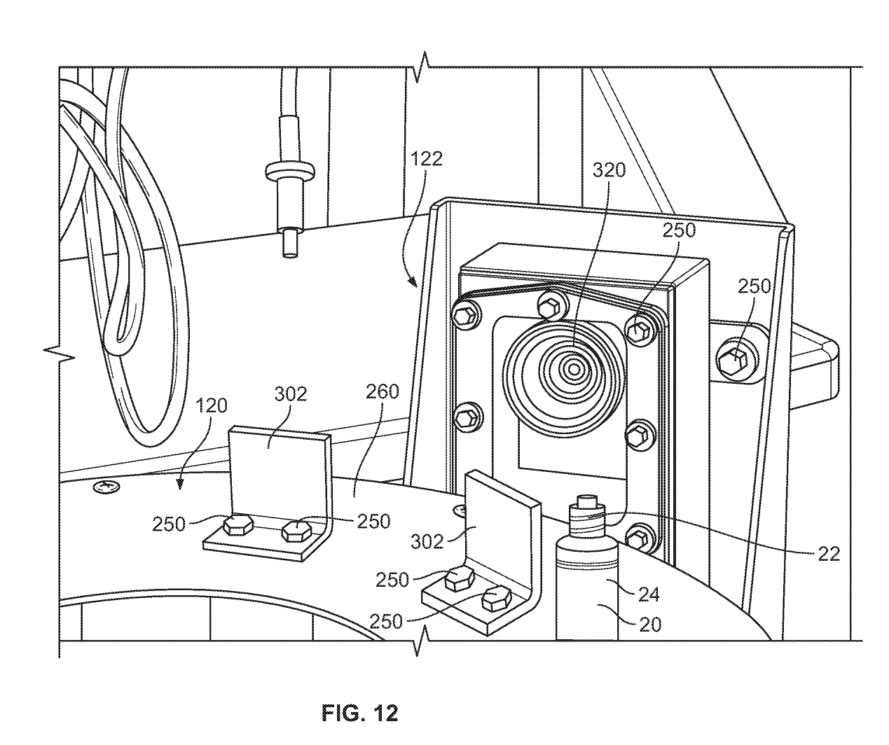

Referring to FIGS. 11 and 12, portions of the first inspection station 122 are shown. The first inspection station 122 includes the adjustment mechanism 300 and a camera or sensor 320. In some embodiments, the first inspection station 122 is located approximately 90 degrees offset from the syringe loader 118, however, the first inspection station 122 may be offset by a different angle. The first inspection station 122 uses image recognition to analyze the unfilled syringes 20 for defects and locations of the gradation markings 28 therealong. The first inspection station 122 includes the camera or sensor 320 (see FIG. 12), which may be an image recognition camera, that is electrically coupled with the one or more controllers 162. In some embodiments, the camera 320 sends information related to the gradation markings 28 to one or more of the controllers 162, and the controllers 162 then provide feedback to one or more components of the filling station 124 related to how much of the compound 42 should be inserted into the one or more syringes 20. In some embodiments, the camera 320 may be a Cognex IN-SIGHT 7200 camera with PatMax, an 8 mm lens, and a Red Light flash. The red flash helps with image quality and reflection. The camera 320 processes an image of each of the syringes 20 and identifies one or more properties of the syringes 20 including, for example, gradation labels, gradation marks, plunger location, and/or plunger shape. The locations of all of these shapes is converted into a distance (in mm) for use when filling the syringe 20. The plunger shape is used to detect a malformed or melted plunger and, if there is an issue with the plunger, the syringe 20 is rejected.

During the filling process, the syringe 20 may be rotated by the adjustment mechanism 300 to ensure that the gradation markings along the syringe 20 are visible by the camera 320. For example, the syringe 20 may be rotated 360 degrees in 90 degree increments by the adjustment mechanism 300. Referring to FIG. 11, the adjustment mechanism 300 may include an adjustment rod 322, rotatably connected with a motor (not shown), and an adjustment cam 324 statically coupled with an end of the rod 322. The adjustment cam 324 may be formed from a rubber, a polymer, or another material, and may include an outer surface having a high coefficient of friction. The adjustment cam 324 is operable to engage in contact with the exterior surface 30 of the syringe 20, and, when the adjustment cam 324 is rotated, spin the syringe 20 around its central axis. The rotation provides the requisite views for the camera 320 to analyze the gradation markings 28 on the syringe 20. In some embodiments, one or more quality checks are done at the first inspection station 122 including determining the quality and location of the gradation marking, determining whether the plunger 26 is a malformed plunger, and determining whether the nozzle 22 of the syringe 20 is damaged. In the event of a failure, the system 100 may alert the operator through a visual, audible, or other alarm that may or may not be associated with the control panel 112.

Referring to FIG. 12, the camera 320 is shown in greater detail. The camera 320 provides visual information, which is processed by the controller 162, which then provides feedback to the operator via the control panel 112 about whether the syringe 20 in the first inspection station 122 passes an initial inspection. Additional information about the syringe 20 may also be sent to the one or more controllers 162, processed, and then output to the operator via the control panel 112. Additional quality checks may be performed at the first inspection station 122, and one or more of the aforementioned quality checks may be excluded from the process. In some embodiments, if one of one of the syringes 20 does not pass the quality inspection, the malformed syringe may be marked as “rejected” and no further operations will be performed on that syringe throughout the rest of the system. The unfilled and uncapped syringe may then be ejected into a syringe bin 340 (see FIGS. 3 and 4).

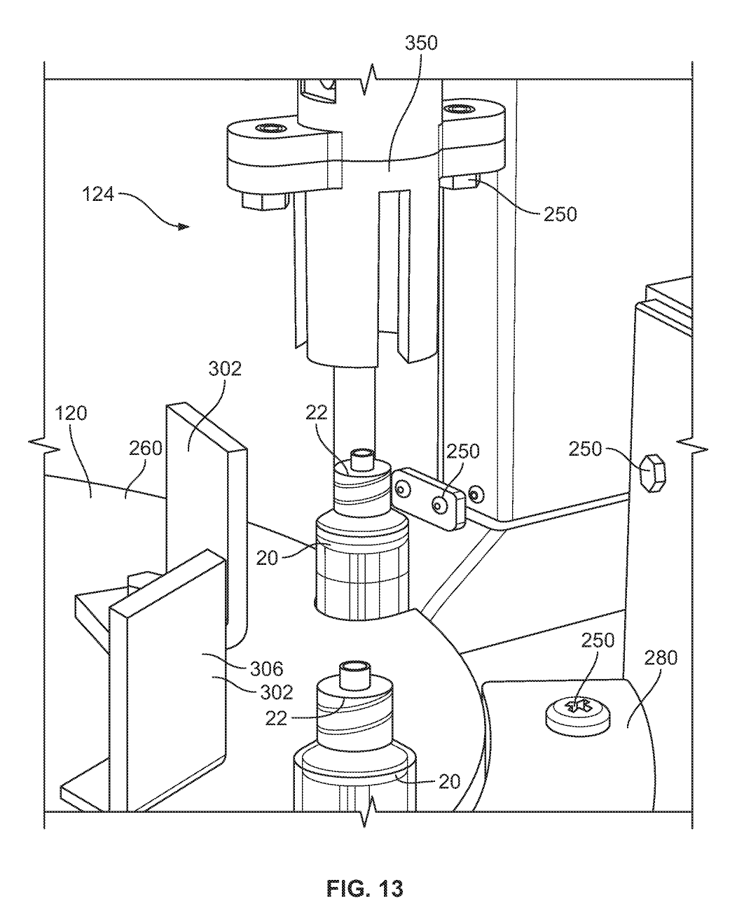

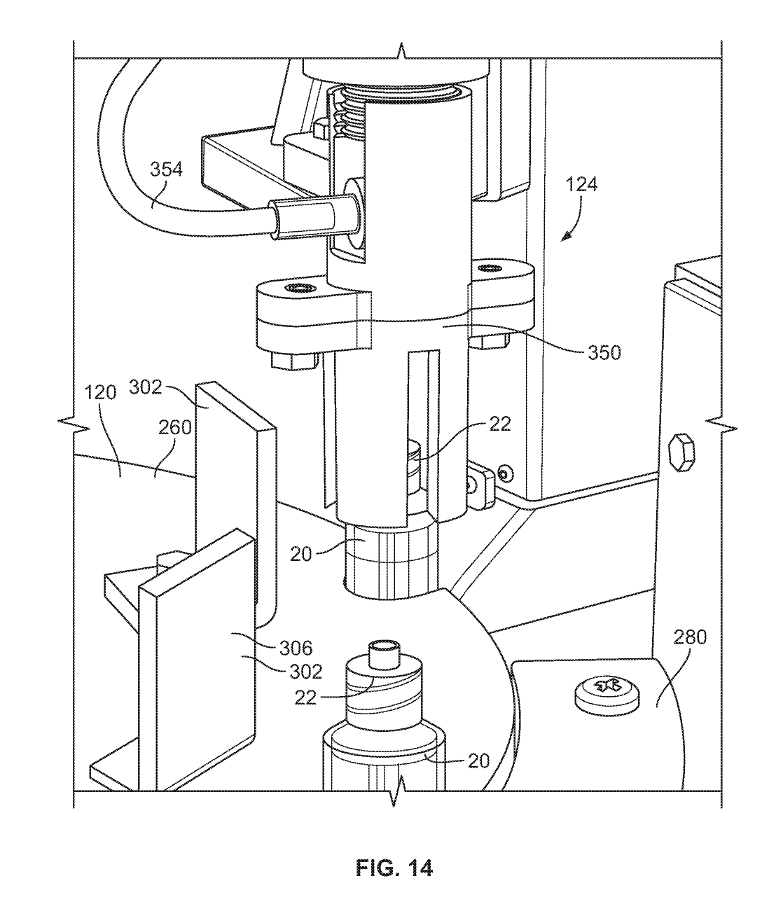

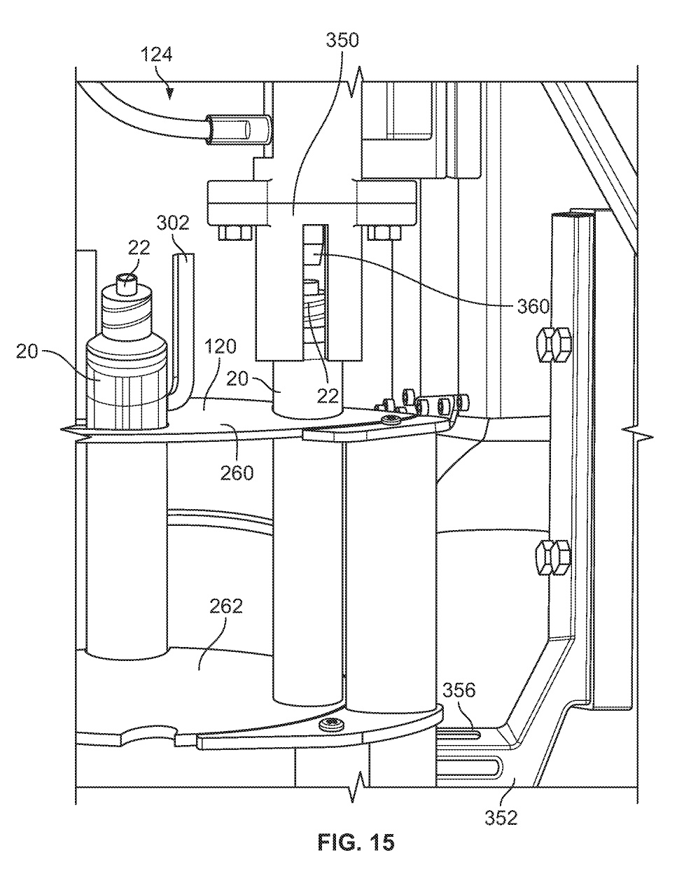

Referring now to FIGS. 13-17, the filling station 124 is shown in a number of different operational states. The filling station 124 is located approximately 45 degrees offset along the starwheel 120 from the first inspection station 122 and includes a filling machine that comprises a filling actuator 350, a plunger actuator 352 (see FIG. 15), and a fill hose 354 (see FIG. 14) that allows the compound 42 to flow from the medicine bag 140 (see FIG. 4) containing the compound 42 to the filling machine 102, which ultimately fills the syringes 20 with the compound 42. Therefore, the filling station 124 is located approximately 135 degrees offset from the syringe loader 118. The filling actuator 350 is operable to move up and down to engage with, and disengage from, the nozzle 22 of the syringe 20 during filling. The plunger actuator 352 includes a plunger arm 356 in the form of a dual prong that is capable of grabbing the plunger 26 of the syringe 20. Both the filling actuator 350 and the plunger actuator 352 are considered system actuators as discussed above.

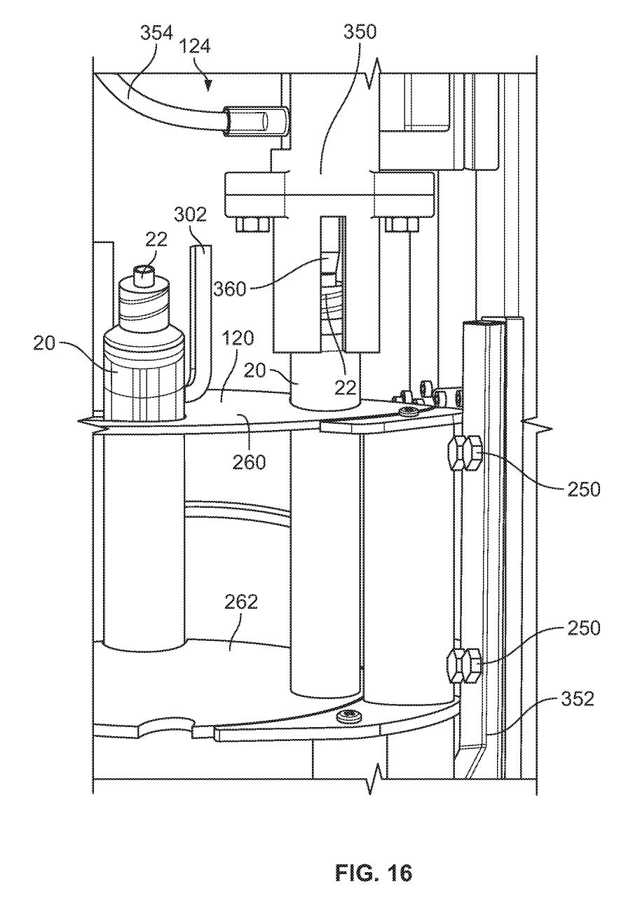

Referring to FIGS. 15 and 16, the plunger actuator 352 is operable to move in a variety of ways so as to contact and move the plunger 26. More specifically, the plunger actuator 352 is designed to move vertically up and down, and is thereby capable of pulling the plunger 26 downward to draw the compound 42 into the chamber 34 of the syringe 20. Additionally, the plunger actuator 352 is also designed to move in a substantially horizontal manner to allow the plunger actuator 352 to contact the plunger 26. An upper wall of the plunger actuator 352 and the plunger arm 356 operate to engage with the thumb rest 32 of the syringe 20 to pull it down during the filling process. The plunger actuator 352 may further be designed to move in a substantially lateral manner. In some embodiments, the plunger actuator 352 is operable to move in three dimensions.

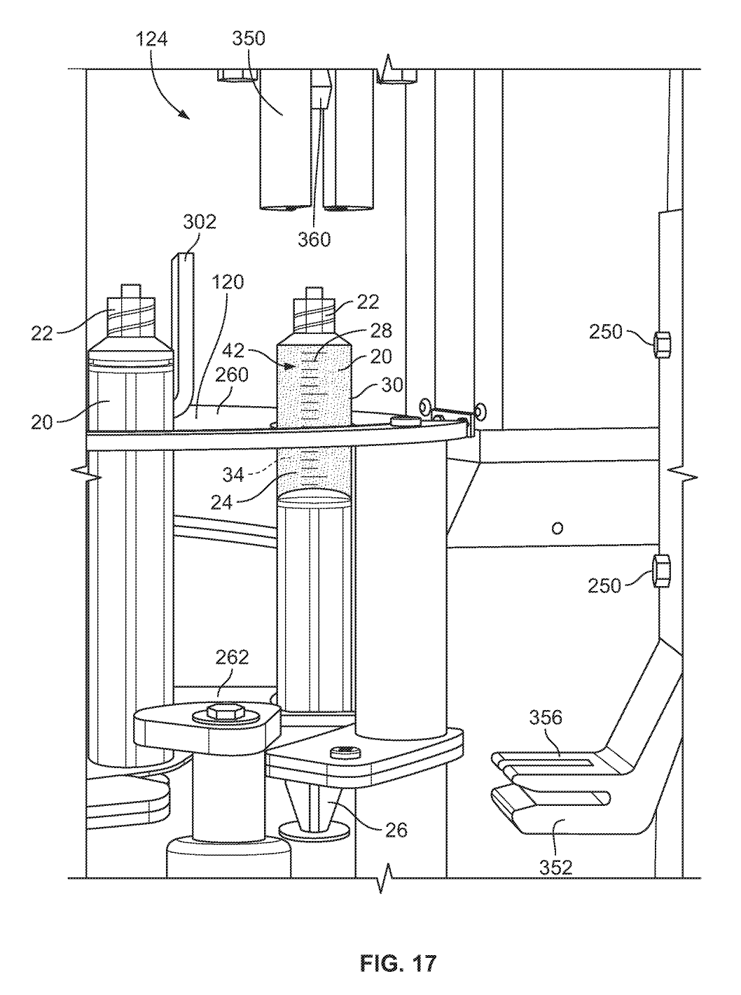

When the syringe 20 reaches the filling station 124, the filling actuator 350 moves downward and securely attaches a valve 360 (see FIG. 15) to the nozzle 22 of the syringe 20. After the valve 360 is engaged with the nozzle 22 of the syringe 20, as shown in FIG. 16, the plunger arm 356 of the plunger actuator 352 grabs the plunger 26, and pulls the plunger 26 downward, which draws the compound 42 into the chamber 34 of the syringe. The syringe 20 is then filled to a desired volume, based on the previously determined level of the gradation markings 28 therealong. After filling, the syringe 20 is detached from the valve 360 (as shown in FIG. 17). The filled syringe 20 is now ready to be moved along to the cap loader 130. In some instances, if an error occurs at the filling station 124, the operator is prompted to clear the error and to reset the filling system 100. The syringe may be marked as “Attention Needed”, or have some other designation, and the machine 102 may pause while the misfiled syringe is at the ejection station.

Referring again to FIG. 3, the second inspection station 126 is shown offset by about 45 degrees from the filling station 124. In other embodiments, the second inspection station 126 may be offset from the filling station 124 by a different angle. The second inspection station 126 includes a secondary camera or sensor 370 that may be the same as the camera 320 of the first inspection station 122. In some embodiments, the second camera 370 is used to determine that the syringe 20 was filled to the correct volume. If a discrepancy is found between the desired fill volume and the measured volume, the syringe 20 may be flagged in the system and marked as “Needs Attention.” The secondary camera 370 is designed to obtain visual information related to the fill level of the syringe 20 after the syringe 20 has been translated, via the starwheel 120, from the filling station 124. In some embodiments, the first camera 320 is the same camera or sensor as the second camera 370. In some forms, the sensors 320, 370 are different. The secondary camera 370 sends visual information that it has obtained to the one or more controllers 162. The one or more controllers 162 subsequently analyze the visual information, thereby performing a quality check on the filled syringes 20 by checking if the syringe 20 was filled to the desired volume. If any of the syringes 20 fail the second inspection check, such syringes 20 may be marked as “Attention Needed”, or may be given another designation. In some embodiments, the machine 102 pauses when any such syringe 20 that is marked “attention needed” reaches the ejection station 132. In some embodiments, the image processing technique uses pattern recognition to identify the gradation markings and numbers. In some instances, a gradation marking may be poorly printed. In such a case, the system may adjust for mistaken markings by using the relative distance of the gradation markings that are properly printed along the syringe 20.

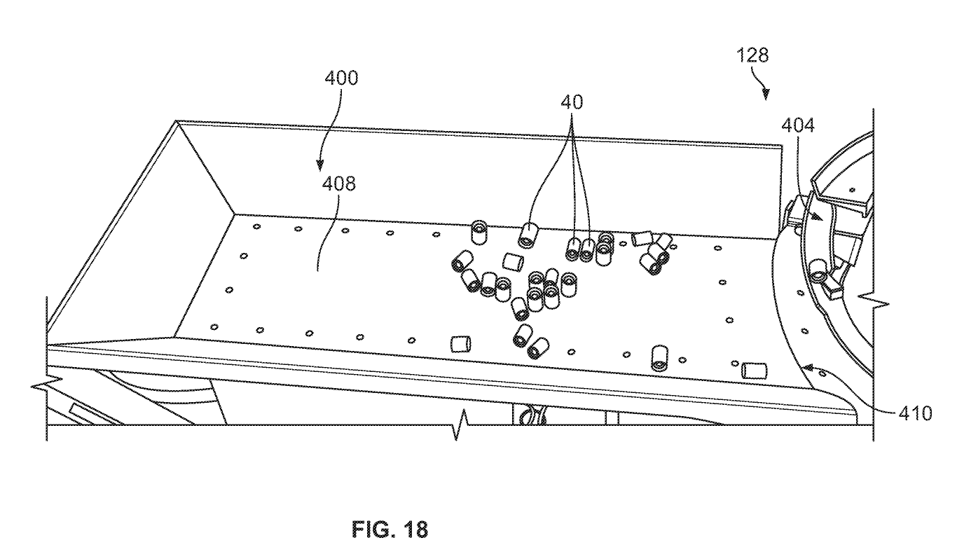

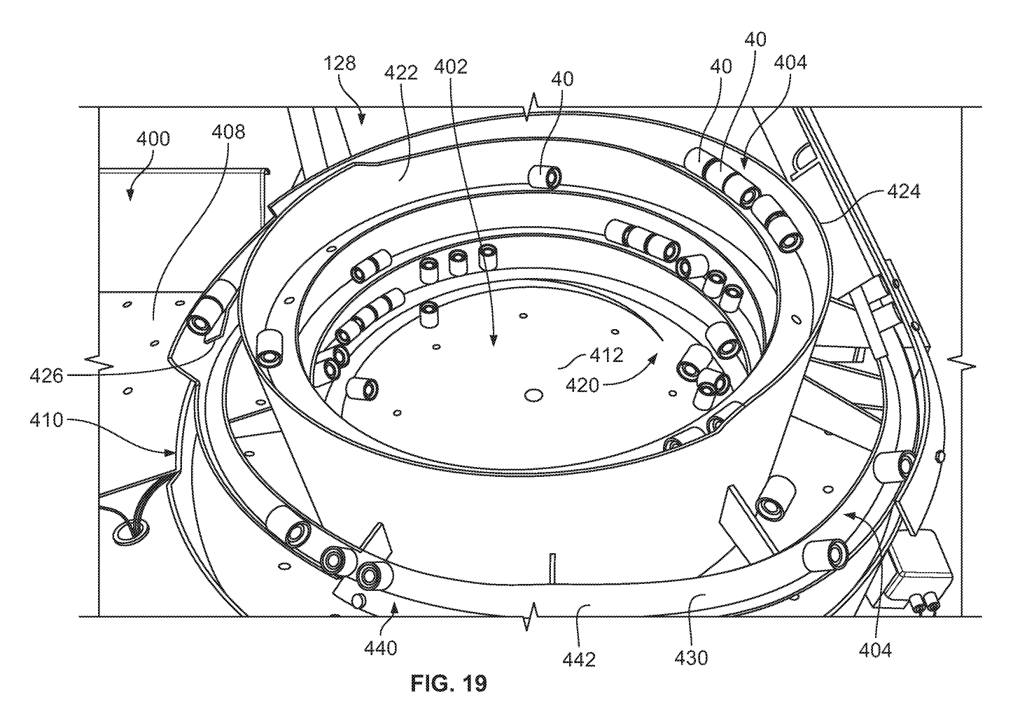

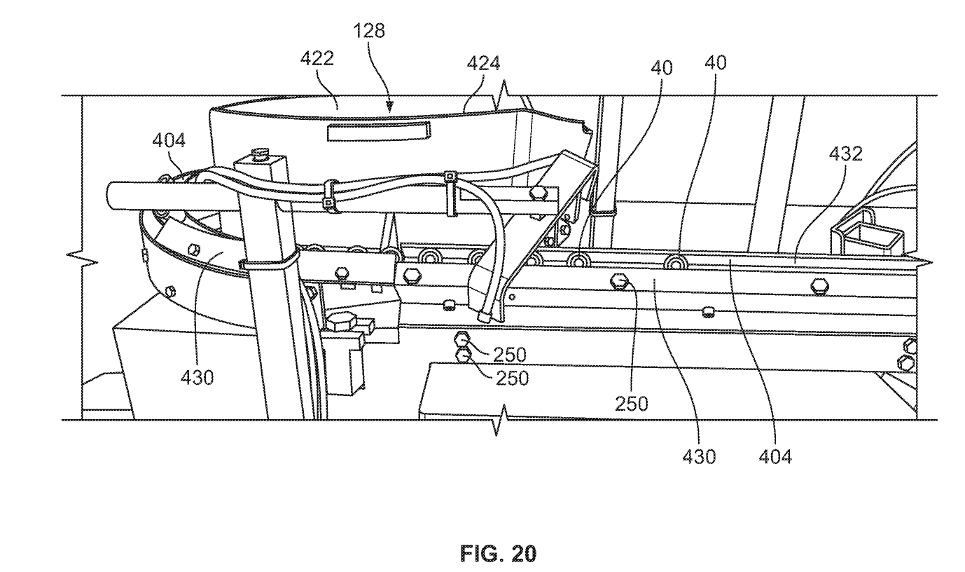

Referring now to FIGS. 18-20, a portion of the cap feeder 128 is shown. The cap feeder 128 is separated into three main sections: a hopper 400, a bowl 402 (see FIG. 19), and a cap track 404 (see FIG. 20). The hopper 400 is shown clearly in FIG. 18. The cap feeder 128 is a fully automated cap acceptance, orientating, and dispensing machine. Boxes of the caps 40 are dumped into the hopper 400 of the cap feeder 128. FIG. 18 illustrates the cap hopper 400 immediately after one or more boxes of the caps 40 have been dumped, either automatically or by an operator, into the hopper 400. The hopper 400 has a vibratory floor 408 that vibrates the one or more caps 40 along until the one or more caps 40 reach an edge 410 (see FIG. 18) of the hopper 400. The edge 410 of the hopper 400 is in communication with the bowl 402, which has a basin 412 that collects the caps 40 that have fallen over the edge 410 of the hopper 400. After the caps 40 have fallen into the basin 412, vibrations of the cap feeder 128 bias the caps 40 toward the cap track 404.

Referring to FIG. 19, the bowl 402 and the cap track 404 are more clearly shown. The bowl 402 includes the basin 412, along which the caps 40 are vibrated until the one or more caps 40 reach the cap track 404. The cap feeder 128 operates in a similar fashion as the syringe feeder 116 in that the vibrations provided thereto cause the caps 40 to move to a desired point. The entire cap feeder 128 vibrates in such a way that the caps 40 are moved along a path from the hopper 400 to where the cap track 404 meets the cap loader 130. The cap track 404 may be a linear track or a spiral track, or the cap track 404 may be a helical track that spirals upward, as depicted.

Referring to FIG. 19, when the caps 40 are disposed along the basin 412 of the bowl 402, the caps 40 are vibrated to an entrance 420 of the cap track 404. Once the caps 40 are vibrated through the entrance 420, the caps 40 are vibrated up the cap track 404. As shown in FIG. 19, the caps 40 may be disposed in any position when climbing the cap track 404, i.e., the caps 40 may be in one of three orientations: right side up, sideways, or upside down. The cap track 404 spirals along an interior side 422 of a cylindrical container 424. At the top of the cap track 404 is a track ledge 426, over which the caps 40 fall onto an orienting track 430. When the caps 40 fall to the orienting track 430, the caps 40 are disposed in one of the three above orientations. The caps 40 that are in an “open-side-up”, i.e., right side up orientation, are able to keep moving along the orienting track 430 and are eventually fed into the cap loader 130. Thus, the correctly oriented caps 40 are moved from the orienting track 430 to a queuing track 432 (see FIG. 20) where the caps 40 are then provided to the cap loader 130. As discussed above, during the entire process of moving the caps 40 from the hopper 400 to the queuing track 432, the caps 40 are continuously exposed to laminar air flow. If the caps 40 are not oriented right side up after falling over the track ledge 426, the improperly oriented caps 40 fall over an edge 440 along a middle portion 442 of the orienting track 430 (see FIG. 19).

Referring to FIGS. 20-23, after the caps 40 are fed through the cap feeder 128, the one or more caps 40 are moved along the queuing track 432 and are received into the capping station by the cap loader 130, which includes a capper 450. The cap loader 130 receives the correctly oriented caps 40 from the cap feeder 128. The cap loader 130 receives the caps 40 from the queuing track 432, which may be a vibrating or sliding track that operates to move the caps 40 along the track via vibration or some other biasing means and with the help of gravity. The caps 40 that have advanced to this point in the system 100, and are correctly oriented, fall down along the queuing track 432 until the caps 40 are queued to be fit onto one of the syringes 20. The queuing track 432 twists approximately 90 degrees, and, as such, the caps 40 are in a generally vertical orientation after leaving the orienting track 430, and are in a generally horizontal orientation by the time the caps 40 reach the cap loader 130.

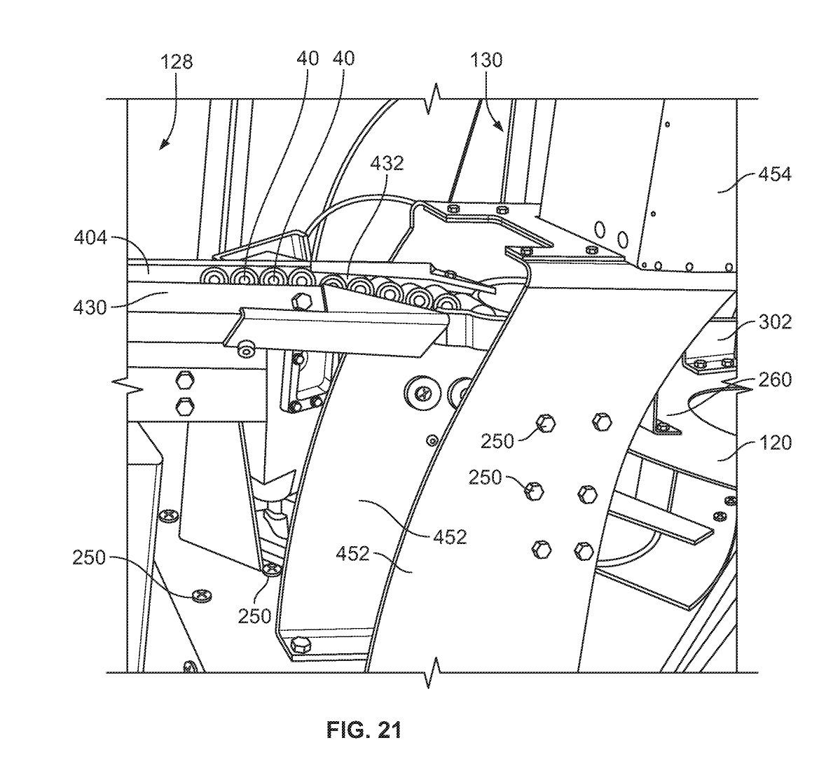

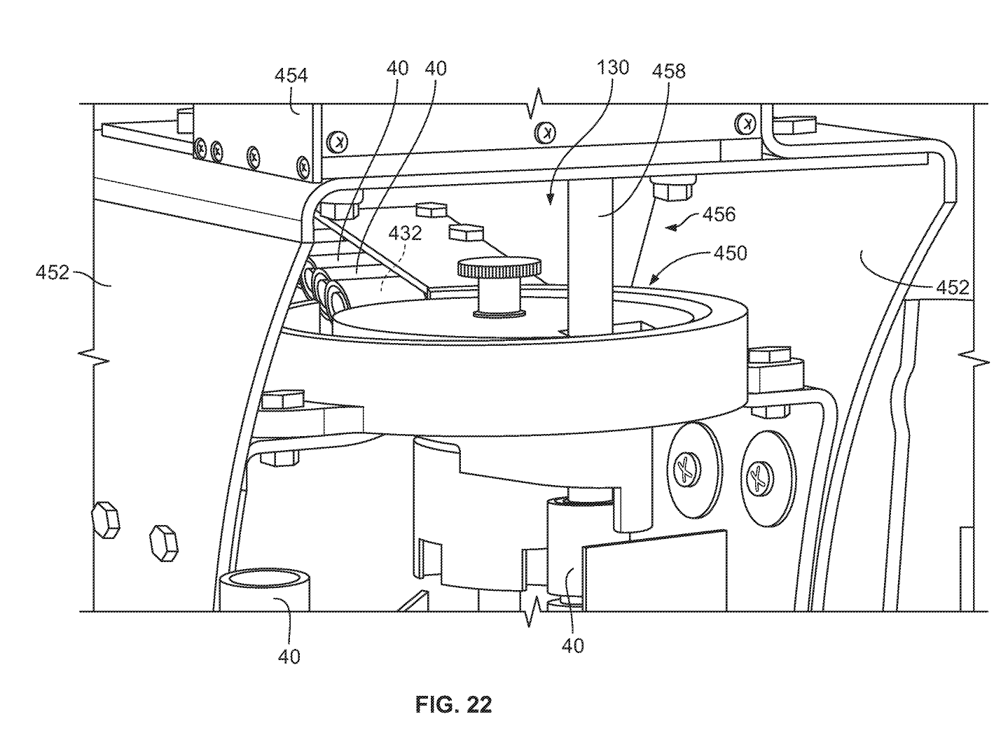

As illustrated in FIG. 21, the cap loader 130 includes a stand 452, which includes one or more stand legs, and further includes a capping housing 454. Partially housed within the capping housing 454 is a capping device 456. The capping device 456 includes a capping rod 458, shown more clearly in FIG. 22. The capping rod 458 may be considered one of the system actuators, as discussed above. The capping rod 458 operates to translate vertically up and down and rotate about its central axis. Once a cap 40 is ready to be placed onto one of the syringes 20, the cap 40 is rotated upright, and engaged with the capping rod 458. The capping rod 458 then translates the cap 40 downward and places the cap 40 onto the nozzle 22 of the filled syringe 20. The capping rod 458 also rotates and fastens the cap 40 securely to the filled syringe 20 through the threading 27 on the nozzle 22 and/or interior surface of the cap 40.

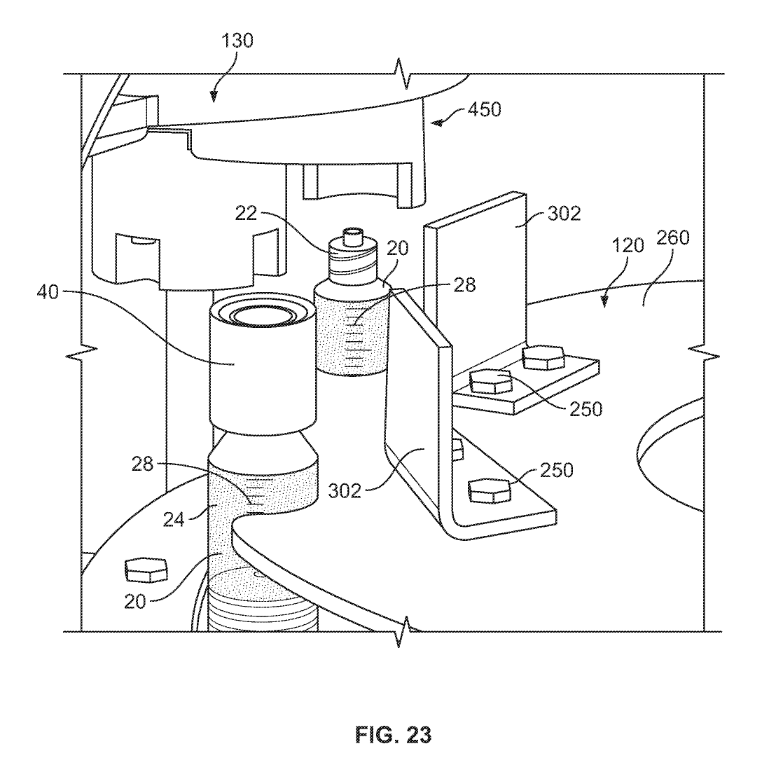

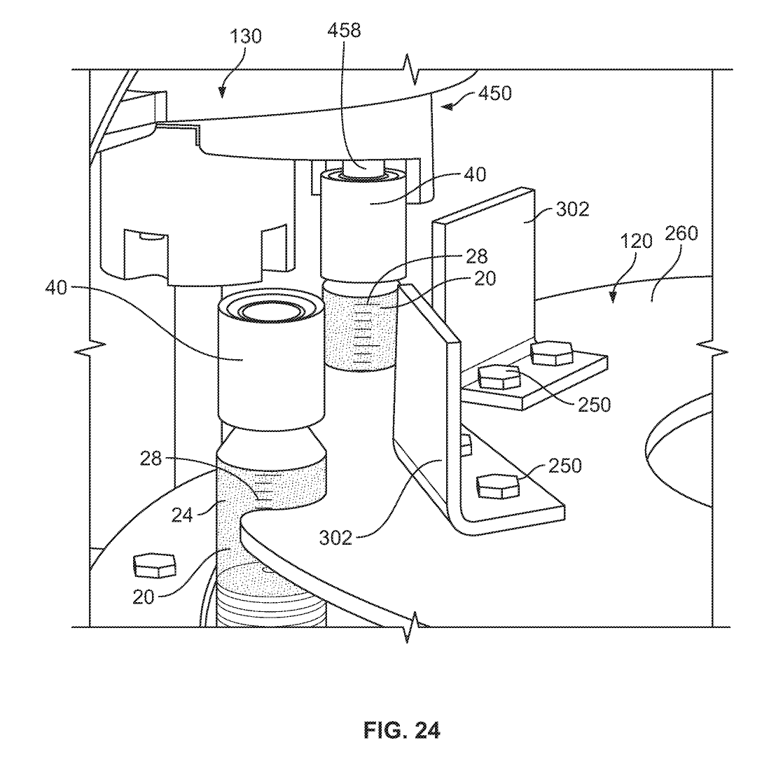

Referring to FIGS. 23 and 24, a filled syringe 20 is shown immediately before capping, and during capping, respectively. The cap loader 130 is removable for cleaning between batches. Various failures can be identified at this stage by one or more sensors along or near the cap loader 130 including a “missing cap” failure or a “failed to tighten cap” failure. If either of these failures occur, the mis-capped syringe may be marked as “attention needed” and the system 100 may pause when the mis-capped syringe reaches the ejection station 132.

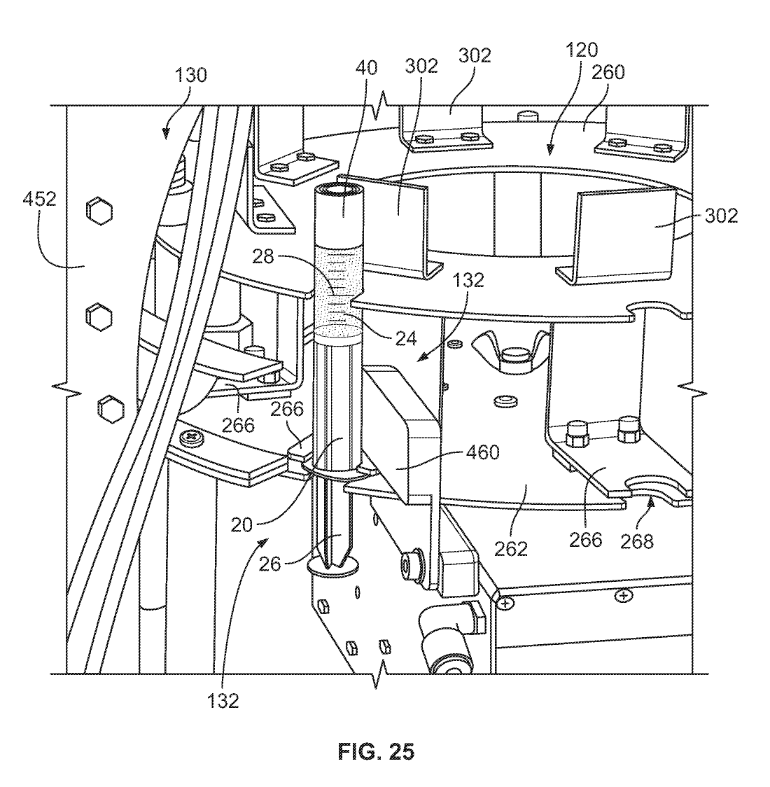

Once the syringe 20 is capped, as shown in FIG. 24, the syringe 20 is revolved, via the starwheel 120, to the ejection station 132, which is shown in FIG. 25. The ejection station 132 is where the syringes 20 are removed from the starwheel 120 and are received into the completed bin 340. A stop 460 operates to push the completed syringes 20 out of the starwheel 120 as the starwheel 120 rotates by the stop 460. If any of the syringes 20 are marked as “Attention Needed,” the system 100 pauses when the identified syringe is at the ejection station 132. The operator can remedy the syringe manually before placing it into the completed bin 340. If the syringe 20 is improperly filled, the operator can fill the syringe with an extra syringe that includes the compound being used. If the syringe 20 is improperly capped, the operator can tighten the cap 40. If the syringe is missing the cap 40, the operator can manually cap the syringe 20.

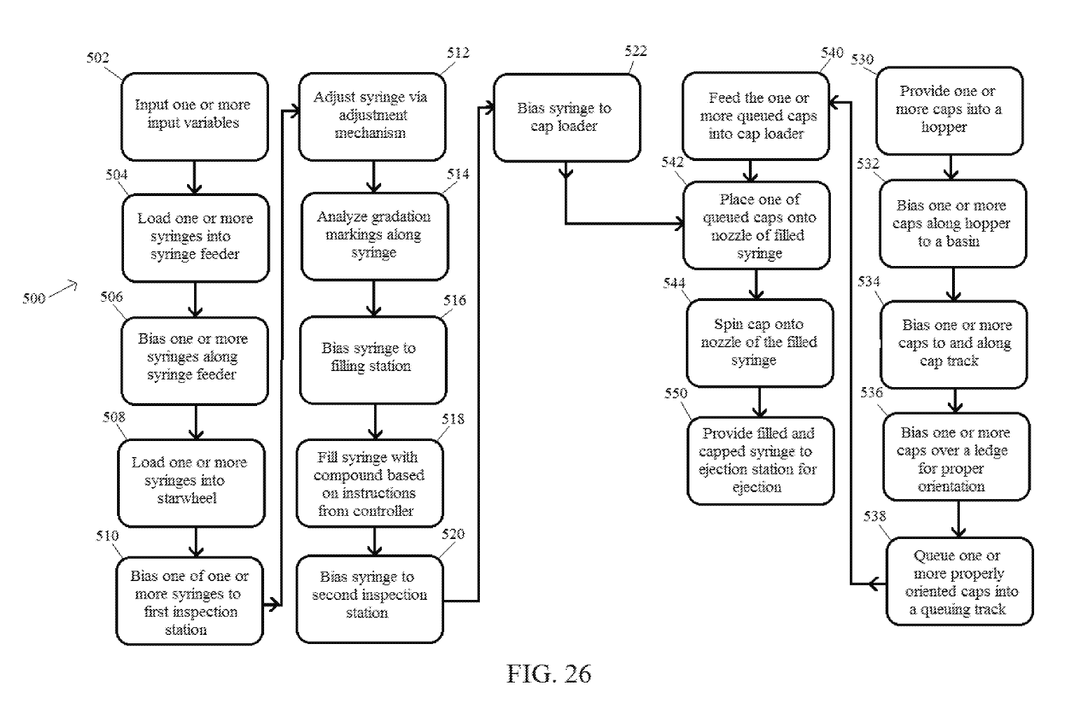

Now referring to FIG. 26, a flow chart is shown that illustrates a method 500 of operating the system 100 as described herein. When the system 100 is turned on, and referring to step 502, a user inputs a variety of input variables including, but not limited to, the number of syringes 20 that will be filled in the current batch, the syringe fill volume, a pass code to confirm the number of syringes and the syringe volume, and a verification that the cleanroom 104, the vacuum system 106, the syringe feeder 116, and the cap feeder 128 are turned on. The syringe fill volume may be between about 2 mL and about 12 mL, or between about 4 mL and about 10 mL, or about 8 mL. Once the operator confirms that the external systems are turned on, the syringe filling system 100 begins to initialize. The operator then ensures that the cap feeder track 200 is full of the caps 40 and that the syringes 20 have reached the end of the syringe feeder. Once these conditions have been satisfied, the operator presses a start button, which may be located along the switch 142, to an “on” configuration to run the filling sequence.

After the components of the system 100 have been powered on, and referring to step 504, the syringes 20 are loaded into the syringe feeder 116. As discussed above, the syringes 20 and the caps 40 may be continually subjected to laminar air flow, especially in instances requiring a sterile operating environment. When loading the syringes 20, an operator pushes each of the syringes 20 into the loading dock 202 so that the thumb rest 32 of the syringe 20 sits along the slide 208 of the loading dock 202 and is slid onto the vibratory track 200. The operator may ensure that the plunger 26 is fully seated in the barrel 24 of the syringe 20 before loading the syringe 20 into the system 100. After loading of the syringes 20, and referring to step 506, the syringes are vibrated along the track 200 until reaching the syringe loader 118. Once arriving at the syringe loader 118, at step 508 the syringes 20 are loaded, one at a time, into the starwheel 120. Referring to step 510, and further referring to a single syringe 20 that has been loaded into the starwheel 120, the syringe 20 is rotated or biased by the starwheel 120 to the first inspection station 122. At step 512, if needed, the syringe 20 may be spun about its own longitudinal axis or otherwise adjusted by the adjustment mechanism 300 such that the first camera 320 can fully analyze the gradation markings 28 along the syringe 20.

Referring to step 514, the first camera 320 obtains visual information regarding the gradation markings 28 along the syringe 20 and sends it to the one or more controllers 162. At step 516, the syringe 20 is moved along or biased to the filling station 124. At the filling station 124, and referring to step 518, the syringe 20 is filled with the compound 42 to an identified level based on the measured gradation markings 28. At step 518, the one or more controllers 162 may provide instructions to the filling station 124 to provide a specified amount of the compound 42 to the syringe 20, and one or more components of the filling station 124 operate to provide that amount of the compound 42 to the syringe 20. Now referring to step 520, the syringe 20 is rotated or biased to the second inspection station 126, where the second sensor or camera 370 obtains additional visual information that is relayed to the one or more controllers 162 that indicates how much of the compound has been provided into the chamber 34 of the syringe 20. At step 522, the syringe 20 is rotated along or biased to the cap loader 130, where it is positioned to be capped with a cap 40.

Referring now to step 530, the capping process will be described. At step 530, one or more caps 40 are provided into the hopper 400 of the cap feeder 128. At step 532, the one or more caps 40 are then biased along the hopper 400 by vibration or some other biasing means until they reach the basin 412 of the bowl 402. At step 534, the one or more caps 40 are biased to and along the cap track 404 until they reach the track ledge 426. At step 536, the one or more caps 40 are vibrated or biased off the ledge 426 and are then oriented in one of the following three orientations: right side up, sideways, or upside down. At step 538, the one or more caps 40 that are in the “right side up” orientation are queued into the queuing track 432. At step 540, the queued caps 40 are fed into the cap loader 130. At step 542, one of the queued caps 40 is grabbed by the capping rod 458 and is placed on the nozzle 22 of the filled syringe 20 that is at the cap loader 130. At step 544, the capping rod 458 spins or otherwise provides the cap 40 securely onto the filled syringe 20. At step 550, the filled syringe having a cap 40 provided thereon is rotated, via the starwheel 120, to the ejection station 132, and are ejected into the syringe bin 340. Additional steps may be included in the method illustrated in FIG. 26, or one or more of the steps may be excluded from the above described process.

The system 100 described herein allows an operator to run multiple batch sizes, which may be beneficial to those who do not require large scale batches of prefilled syringes. Further, an operator can provide a plurality of syringes into the system 100, while some systems require a cartridge of a pre-set number of syringes. Still further, the system 100 described herein is adaptable and configurable to different combinations of syringes and caps having various sizes, shapes, volumes, materials, and the like.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A system for filling a syringe, comprising:
a syringe filling machine including:
a syringe feeder;
a syringe loader coupled with the syringe feeder;
a starwheel designed to move the syringe in a circular pattern therearound;
one or more inspection stations positioned around the starwheel and configured to detect an error in the syringe;
a syringe filling station adjacent the starwheel that fills the syringe with a compound;
a cap feeder;
a cap loader in communication with the cap feeder and adjacent the starwheel; and
an ejection station adjacent the starwheel.

2. The system of claim 1 further comprising a cleanroom and a vacuum system adjacent the syringe filling machine.

3. The system of claim 1, wherein the syringe filling machine further includes a control station.

4. The system of claim 1, wherein the cap feeder includes a hopper, a basin, and a track.

5. The system of claim 4, wherein the cap feeder is a vibratory cap feeder and the track is a spiral track.

6. The system of claim 1, wherein the syringe loader includes an arm and a claw, the arm being actuated by a syringe actuator to introduce the syringe into the starwheel.

7. The system of claim 1, wherein the starwheel includes at least eight syringe cutouts.

8. The system of claim 1, wherein the one or more inspection stations each include a camera, and
wherein the cameras are operable to detect a plurality of gradation markings along the syringe.

9. A system for filling a plurality of syringes, comprising:
a syringe filling machine including:
a syringe feeder having a vibratory track;
a syringe loader coupled with the syringe feeder;
a starwheel rotatable about a central axis;
a first inspection station having a camera provided adjacent the starwheel and a second inspection station having a camera provided adjacent a different section of the starwheel;
a syringe filling station adjacent the starwheel;
a cap feeder operable to align a plurality of caps in a capping orientation; and
a cap loader in communication with the cap feeder,
wherein the starwheel is operable to move the plurality of syringes between the two inspection stations, the syringe filling station, and the cap loader.

10. The system of claim 9, wherein the starwheel includes an upper disc and a lower disc connected via one or more legs.

11. The system of claim 9, wherein the syringe filling station includes a plunger actuator and a filling actuator.

12. The system of claim 9, wherein the cap feeder includes a spiral track that biases the one or more caps toward the cap loader.

13. The system of claim 9, wherein the cap loader includes a capping arm that is vertically and rotatably translatable.

14. The system of claim 9 further comprising a controller in electrical communication with the first and second cameras,
wherein the first camera is operable to identify a plurality of gradation markings along a syringe, and the second camera is operable to identify a fill level of the syringe.

15. A method of filling one or more syringes, comprising:
inputting one or more variables via a user interface,
loading the one or more syringes into a syringe loader;
loading the one or more syringes into a starwheel;
biasing the one or more syringes in a circular pattern via the starwheel, to at least the following stations:
a first inspection station;
a filling station;
a second inspection station; and
a cap loader;
providing one or more caps to a cap feeder;
biasing the one or more caps to the cap loader; and
securing the one or more syringes with one of the one or more caps.

16. The method of claim 15, wherein the variables include one or more of a number of syringes to be filled, a syringe volume, a pass code, and a verification that one or more components are switched to an on configuration.

17. The method of claim 15 further comprising ejecting the one or more syringes into a syringe bin.

18. The method of claim 15, wherein the step of providing one or more caps to the cap feeder includes:
biasing the one or more caps
along a hopper to a bowl,
from the bowl to a track, and
along the track until the one or more caps fall off of a cap ledge.

19. The method of claim 18 further comprising queuing the one or more caps along a queuing track.

20. The method of claim 19, wherein the queuing track is a vibratory track.
